(19) United States
(12) Patent Application Publication
(10) Pub. No.: US 2016/0230083 A1
(43) Pub. Date: Aug. 11, 2016

(54) Lightweight Proppants for Hydraulic Fracturing

(71) Applicant: BOARD OF REGENTS, THE UNIVERSITY OF TEXAS SYSTEM, Austin, TX (US)

(72) Inventors: Kishore K. Mohanty, Austin, TX (US); Krishna K. Panthi, Austin, TX (US)

(21) Appl. No.: 15/023,102

(22) PCT Filed: Sep. 19, 2014
(86) PCT No.: PCT/US14/56577

§ 371 Date: Mar. 18, 2016

Related U.S. Application Data
(60) Provisional application No. 61/882,392, filed on Sep. 25, 2013.

(51) Int. Cl. C09K 8/80

(52) U.S. Cl. CPC C09K 8/80

(57) ABSTRACT

The present invention includes a lightweight proppant comprising a composite comprising a polymer and clay or graphite, wherein the composite has a density at or about the density of water or brine and the composite maintains its integrity at downhole pressures and temperatures.

### TECHNICAL FIELD OF THE INVENTION

The present invention relates in general to the field of proppant for hydraulic fracturing, and more particularly, to improved lightweight composite proppants.

### BACKGROUND OF THE INVENTION

Without limiting the scope of the invention, its background is described in connection with proppants.

U.S. Pat. No. 7,726,399, issued to Brannon, et al., is directed to a method of enhancing hydraulic fracturing using ultra lightweight proppants. Briefly, a subterranean formation that is to be subjected to hydraulic fracturing is first pre-treated with an ultra lightweight (ULW) proppant having an average particle size between from about 12/20 to about 40/70 and flows into the natural fractures to pack the fractures.

U.S. Pat. No. 7,521,389 issued to Shmotev, et al., is directed to a ceramic proppant with low specific weight. Briefly, a precursor composition for the production of granulated ceramic material or proppants is made that comprises 20 to 55% by weight of magnesium orthosilicate, 20 to 35% by weight of MgO, and 2.5 to 11% by weight of Fe₂O₃. The resulting lightweight proppant material shows high mechanical strength. To further decrease the specific density of the proppant, the formation of small pores can be made by adding 0.3 to 2.4% carbon as a gas-forming agent.

U.S. Pat. No. 7,036,591 issued to Cannan, et al., is directed to a low density proppant. Briefly, a low density, spherical proppant is made from kaolin clay having an alumina content distributed homogeneously throughout the pellets, an apparent specific gravity of from about 1.60 to about 2.10 g/cc, and a bulk density of from about 0.95 to about 1.30 g/cc. The low density is achieved by controlling the time and temperature of the firing process to be from about 1200° C. to about 1350° C. This low density proppant is said to be useful in hydraulic fracturing of shallow oil and gas wells.

U.S. Pat. No. 6,753,299 issued to Lunghofer, et al., is directed to composite silica proppant material. Briefly, a lightweight and highly permeable proppant composition includes equal amounts by weight of uncalcined bauxite, uncalcined shale and quartz, held together with a binder formed of wollastonite and talc in an amount of less than 10% by weight of the composition. The proppant composition has an alumina content of less than 25% by weight of the composition and a silica content of over 45% by weight of the composition.

United States Patent Application Publication No. 2012/0149610, filed by Parse, et al., is directed to multiple component neutrally buoyant proppants. Briefly, these applicants teach a proppant that demonstrates a reduced specific gravity by controlling the geometry of the structure of the proppant that has a tubular structure hollow in the center with a wall of material sufficiently strong to withstand the majority of closure pressures.

United States Patent Application Publication No. 2012/0118574, filed by Li, et al., is directed to a composition and method for producing an ultra-lightweight ceramic proppant. Briefly, these applicants teach an ultra-lightweight, high strength ceramic proppant made from mixture of naturally occurring clays, preferably porcelain clay, kaolin and/or flint-clay, earthenware clay or other naturally occurring clays having an alumina content between about 5.5% and about 35%. The proppant has an apparent specific gravity from about 2.10 to about 2.55 g/cc, and a bulk density of from about 1.30 to about 1.50 g/cc. This ultra-lightweight proppant is useful in hydraulic fracturing of oil and gas wells, and has greater conductivity than sand at pressures up to 8,000 psi.

United States Patent Application Publication No. 2008/0179057, filed by Dawson is directed to well treating agents of metallic spheres and methods of using the same. Briefly, this applicant teaches a hollow non-porous metallic spheres may be used in treatment of subterranean formations, including hydraulic fracturing and sand control methods, having a diameter ranging from about 4 mesh to about 100 mesh. When employed in deep water environments having high closure stresses, the spheres have a thicker wall and are characterized by the higher ASG, typically between 2.5 to about 4.0. The ASG of the spheres, when less harsh environments are encountered, is generally ultra lightweight (ULW) with an apparent specific gravity (ASG) less than or equal to 2.0. Fracture conductivity may be increased by the placement of the hollow non-porous metallic spheres as a partial monolayer.

### SUMMARY OF THE INVENTION

The present invention includes a lightweight proppant comprising: a composite comprising a polymer and clay or graphite, wherein the composite has a density at or about the density of water or brine and the composite maintains its integrity at downhole pressures and temperatures. In one aspect, the clay is at least one of montmorillonite, kaolinite, hectorite, or smectite. In another aspect, the monomer is at least one of styrene, methyl methacrylate, propylene, or chloroprene. In another aspect, the polymerizing of the monomers into a polymer is conducted in the presence of at least one of acetonitrile, vinyl chloride, vinyl alcohol, acrylonitrile, benzoyl peroxide, or 2,2′-azobis(isobutyronitrile). In another aspect, the composite further comprises an additive that makes the proppant electrically conductive. In another aspect, the density of the composite is adjusted to approximate the density of the water or brine. In another aspect, the density of the composite is between 0.94 to 1.5 g/cc, 0.94 g/cc to 1.10 g/cc, 0.98 g/cc to 1.0 g/cc, 0.94 to 1.0 g/cc, or 0.94 to 0.98 g/cc. In another aspect, the clay or graphite to monomer ratio is 1:2.66 to 1:1. In another aspect, the proppant has a Young's Modulus of at least 50,000; 75,000; 100,000; 150,000; 175,000; 200,000; 225,000; 230,000 or greater.

Another embodiment of the present invention includes a method of making a lightweight proppant comprising: mixing clay or graphite with one or more polymer-forming monomers; and polymerizing the monomers into a polymer, wherein the one or more monomers are selected to form, in combination with the clay or graphite, a composite comprising a polymer and clay or graphite, wherein the composite has a density at or about the density of water or brine and the composite maintains its integrity at downhole pressures and temperatures. In one aspect, the polymerization is in situ and comprises a polymerization at 50° C. to 70° C. for 2 to 8 hours, followed by second polymerization at 85° C. to 95° C. for 8 to 16 hours. In another aspect, the monomer is at least one of styrene, methyl methacrylate, propylene, or chloroprene. In another aspect, the step of polymerizing of the monomers into a polymer is conducted in the presence of at least one of acetonitrile, vinyl chloride, vinyl alcohol, acrylonitrile, benzoyl peroxide, or 2,2′-azobis(isobutyronitrile). In another aspect, the composite further comprises an additive that makes the proppant electrically conductive. In another aspect, the clay is at least one of montmorillonite, kaolinite, hectorite, or smectite. In another aspect, the density of the composite is between 0.94 g/cc to 1.5 g/cc, 0.94 g/cc to 1.10 g/cc, 0.98 g/cc to 1.0 g/cc, 0.94 to 1.0 g/cc, or 0.94 to 0.98 g/cc. In another aspect, the clay or graphite to monomer ratio is 1:2.66 to 1:1. In another aspect, the proppant has a Young's Modulus of at least 50,000; 75,000; 100,000; 150,000; 175,000; 200,000; 225,000; 230,000 or greater. In another aspect, the method further comprises the steps of determining the density of the water or brine, preparing a sample of the proppant and determining the density of the proppant, and adjusting the density of the proppant to approximate the density of the water or brine. In another aspect, the water is at least one of a produced water, or the brine is a produced brine. In another aspect, the method further comprises the step of determining a target density and adjusting the ratio of clay to monomer to the target density.

Yet another embodiment of the present invention includes a method of fracturing a hydrocarbon bearing formation within a well comprising: placing a proppant in a fracture, wherein the proppant has a density at or about the density of water or brine and the composite maintains its integrity at well pressures and temperatures. In one aspect, the monomer is at least one of styrene, methyl methacrylate, propylene, or chloroprene. In another aspect, the step of polymerizing of the monomers into a polymer is conducted in the presence of at least one of acetonitrile, vinyl chloride, vinyl alcohol, acrylonitrile, benzoyl peroxide, or 2,2′-azobis(isobutyronitrile). In another aspect, the clay is at least one of montmorillonite, kaolinite, hectorite, or smectite. In another aspect, the density of the composite is between 0.94 g/cc to 1.5 g/cc, 0.94 g/cc to 1.10 g/cc, between 0.98 g/cc to 1.0 g/cc, 0.94 to 1.0 g/cc, or 0.94 to 0.98 g/cc. In another aspect, the clay or graphite to monomer ratio is 1:2.66 to 1:1. In another aspect, the method further comprises the step of adding an additive that makes the composite electrically conductive. In another aspect, the proppant is introduced in a hydraulic fracturing fluid pumped into the well at sufficient pressure to fracture the formation.

### BRIEF DESCRIPTION OF THE DRAWINGS

For a more complete understanding of the features and advantages of the present invention, reference is now made to the detailed description of the invention along with the accompanying figures and in which:

FIG. 1 is a drawing that shows a proposed in-situ polymerization reaction of clay and monomer.

FIG. 2 shows a bulk density measurement using heptane as a liquid.

FIG. 3 shows a broken piece of proppant #2 to show how polymer-clay bind each other.

FIG. 4 is a graph that shows a strength test for proppant #1 at room temperature (25° C.) and at 95° C.

FIGS. 5A and 5B show proppant #1 (L=1.1 inch, D=0.408 inch), before a crush test (FIG. 5A) and (after crush test at 95° C. FIG. 5B).

FIG. 6 is a graph that shows a strength test for proppant #2 at 95° C. and at 120° C.

FIGS. 7A and 7B show proppant #2 (L=0.7 inch, D=0.33 inch), before a crush test (FIG. 7A) and after crush test at 95° C. (FIG. 7B).

FIG. 8 is a graph that shows a strength test for proppant #3 at room temperature and at 95° C.

FIG. 9 is a graph that shows an elastic modulus for proppant #1 at room temperature (25° C.) and at 95° C.

FIG. 10 is a graph that shows an elastic modulus for proppant #2 at 95° C. and at 120° C.

FIG. 11 is a graph that shows an elastic modulus for proppant #3 at room temperature and at 95° C.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Hydraulic fracturing is crucial for the success of oil and gas production from shales because of their extremely low permeability. A fracture needs to be long and propped to maximize reservoir contact. The use of slick water fracturing has increased over the last decade because of large stimulated volume and lower cost fluids. A potential drawback of using slick water with sand is its inability to transport conventional proppants deep into the fractures (Gadde and Sharma, 2005). Proppants settle near the wellbore during the fracturing process before reaching the end of the long fracture. The fracturing fluid can carry the heavy sand proppants if the fluid is polymeric, but polymers can plug the fracture faces of low permeability shales (Kaufman and Penny, 2008).

One option to overcome these problems is to use lightweight proppants that can be transported by simpler fracturing fluids like slick water (Aboud & Melo, 2007; Brannon et al., 2004; Rickards et al., 2006). Cawiezel & Gupta (2010) have suggested the use of viscoelastic foamed fracturing fluids with light-weight proppants for low permeability reservoirs, but it is not clear whether these proppants can bear the stresses expected in various shale formations and provide enough fracture conductivity. Gaurav et al. (2012) studied the efficacy of light weight proppants by studying their fracture conductivity and strength. These proppants are light, but not strong enough at high temperatures.

The present invention includes compositions and methods for synthesizing economically viable lightweight polymer-clay composite proppants. The novel lightweight polymer-clay composite proppants were evaluated for fracturing of shale gas reservoirs. Proppants with different density (slightly lighter than water and slightly heavier than water) have been synthesized and their bulk strength measured at room temperature, 95° C. and 120° C.

Long, propped hydraulic fractures need to be placed in shale reservoirs to have economic productivity. The commonly used technique, slick water fracturing with sand, gives long fractures, which are not propped throughout their length. Most of the conventional proppants like sand and ceramics are much denser than water. The newly invented proppants are strong, but have a density close to that of water, which will lead to long, propped fractures.

There is an alternative technology of using polymer gels with water to viscosify water to carry the proppants (sand and ceramics) deep into fractures. But the polymer gels can plug up the fracture face of shales, which have very small pores. That is why this technology is not used commonly in shale fracturing. The newly invented proppants do not need a viscous fluid because their density is close to that of water.

There are some ultra lightweight proppants commercially available of density 1.08 g/cc. They are polymeric and not very strong (Young's modulus about 20,000 psi). The newly invented proppants are stronger (Young's modulus about 200,000 psi) and work under downhole temperatures and pressures, using existing solutions common to fracturing formations. The polymer composites of the present invention can be made with different ratios of, e.g., clay to polymer, and can be synthesized in presence of a reaction initiator. The composites can be made by the reaction of different types of clays and commercially available inexpensive monomers. The proppants can controlled in the range of 0.9 to 1.5 g/cc by tailoring the ratio of clay to monomer and can also be made electrically conductive by using, e.g., graphite flakes as an additive and/or instead of clay. This invention includes the mixture of clay (or graphite) and monomers where in-situ polymerization results in a composite of polymer and covalently-bonded, inter-linked clay (or graphite) particles. These composite particles are strong because of the presence of inter-linked clay (or graphite) particles. The proppants of the present invention have a density around that of water and sufficiently strong enough to withstand the net overburden pressure and can be used in hydraulic fracturing of oil and gas wells along with simple fracturing fluid (e.g., slick water) for creating long and propped hydraulic fractures. By having a density (or adjusting the density) to that of the fracturing fluid the present invention can flow with the slick water to the end of fractures. Thus, the full fracture length can be propped leading to a high productivity from, e.g., shale reservoirs. Unlike lightweight proppants in the prior art, which are only polymeric, the proppants of the present invention have a higher strength at both high pressure and temperature. By making the proppants of the present invention electrically conductive, the present invention can also be used for imaging the implemented geometry of the hydraulic fractures.

Another advantage of the present invention is that it can be easily incorporated into existing methodologies using, e.g., existing equipment and fluids. Unlike existing ceramic or sand proppants, which have densities much higher than water, the present invention solves a critical problem with reaching the full length of the fracture without the proppant settling at the front of the fracture and not reaching the full length of the fracture. Thus, the proppants of the present invention do not settle in the fracture near the wellbore region, as is found with existing proppants.

The present invention includes several distinct advantages and special characteristics when compares to existing technology, for example, (1) density of the proppants is close to that of water; (2) The density can be tuned in the range of 0.95 to 1.5 g/cc; (3) the proppants are strong; Young's modulus in the range of 150,000-250,000 psi; and (4) the composite proppants containing graphite can be electrically conductive which can be used in imaging of fractures.

The newly invented material can be used as a proppant in hydraulic fracturing of, e.g., shales. The fracturing fluid can be, e.g., slick water, as such, there is no need to viscosify the fluid to carry the proppants. Mixtures of sand and these proppants can also be used where the near wellbore region is propped with the higher density sand and the deep fracture regions are propped with the new proppant. The composite proppants containing graphite can be electrically conductive which can be used in imaging of fractures.

In one non-limiting example, the clay is at least one of montmorillonite, kaolinite, hectorite, or smectite. The skilled artisan will recognize, based on the current disclosure, that additional materials may be substituted that have clay-like characteristics, which are also encompassed by the present invention.

In one non-limiting example, the monomer is at least one of styrene, methyl methacrylate, propylene, or chloroprene. The skilled artisan will recognize, based on the current disclosure, that additional materials may be substituted that have characteristics similar to the monomers taught herein, which are also encompassed by the present invention.

In one non-limiting example, the polymerizing agent for converting the monomers into a polymer and the conditions under which the polymerization will occur are known in the art and may be conducted in the presence of at least one of, e.g., acetonitrile, vinyl chloride, vinyl alcohol, acrylonitrile, benzoyl peroxide, or 2,2′-azobis(isobutyronitrile). The skilled artisan will recognize, based on the current disclosure, that additional materials may be substituted to trigger the polymerization of the monomers, which are also encompassed by the present invention.

Materials: Clay (montmorillonite), graphite, acrylonitrile, styrene, and 2,2′-azobis(2-methyl-propionitrile) (AIBN) were purchased from Fisher scientific.

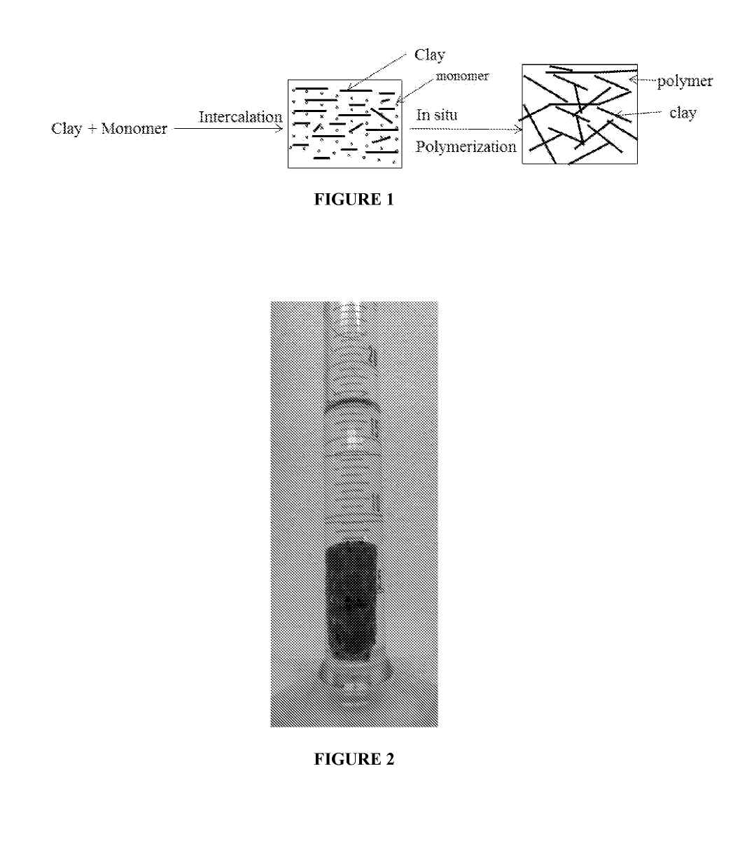

Synthesis: Styrene, acrylonitrile and azobis(2-methyl-propionitrile) were thoroughly mixed at the required amount into a reaction flask and clay was added on it. To ensure the complete absorption of the monomers into the clay particles, the closed flask was kept at room temperature for 12 hours, and the mixture was shaken occasionally. The in situ polymerization of styrene and acrylonitrile inside the pores of clay particles was first carried out at 60° C. for 6 hours, followed by polymerization at 90° C. for another 12 hours. A proposed, general reaction is represented in the FIG. 1, however, FIG. 1 is for illustration purposes only and does not serve the limit the invention. The resultant poly(St-co-AN)/clay composite particles were obtained in the form of one semi-solid piece. The composite particles could be transferred to a preheated compression mold where they could be extruded into different shapes and sizes. FIG. 1 shows a diagram of the in-situ polymerization reaction of clay and monomer.

Measurement of Physical Properties. Bulk Density: A piece of the composite material was first weighed. As shown in FIG. 2, the proppant piece was then placed in a graduated glass cylinder having a known amount of heptane and the increase in bulk volume was measured. As some of the proppants are lighter than water, we used heptane as a liquid to measure the density of all proppants. This process was repeated three times for each proppant and average value was considered for the calculation of density. After measuring the mass of proppant (M), and volume of heptane (V) displaced by the proppant piece, the density (D) was calculated by using the formula D=M/V. FIG. 2. Bulk density measurement using heptane as a liquid.

Strength and Crush Test: A Humboldt press was used for evaluating the strength of the proppant material. The equipment has three parts, top piston, bottom piston and cylindrical sleeve. The whole equipment is made out of aluminum to keep the tool light in weight, but, the surfaces of the pistons, which are in contact with the proppant piece are made out of tool steel, so that proppant does not embed into the equipment during the test. The equipment is placed in a Humboldt press machine. It is to be noted here that the whole set-up is designed in a way that a strain is applied and the resulting stress is measured.

This test was conducted at three different temperatures (room temp, 95° C. and 125° C.). For higher temperature tests, the proppant material was heated in an oven for overnight. Then the sample was removed from the oven and the stress study was conducted quickly.

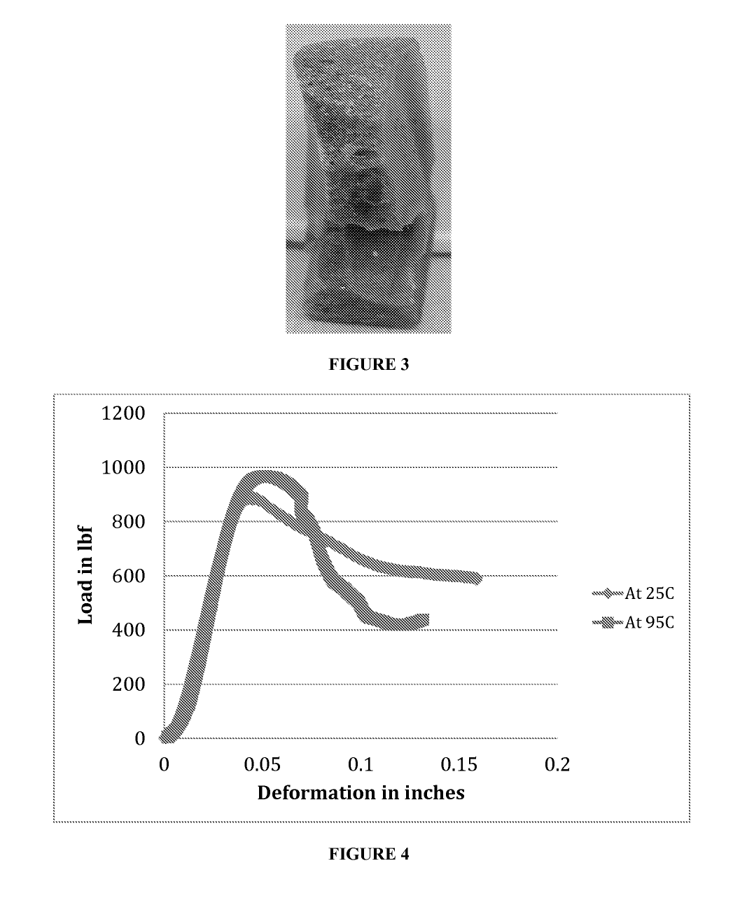

Synthesis: Three different proppants were synthesized with the ratio of clay to monomers as 1:2.66 (proppant #1), 1:1:77 (proppant #2), and graphite to monomers as 1:2.66 (proppant #3) respectively. The density of the proppant #1 (clay to monomer ratio as 1:2.66) was obtained as 0.94 g/cc, proppant #2 (clay to monomer ratio of 1:1.77) was obtained as 1.10 g/cc and for proppant #3 (graphite to monomer ratio as 1:2.66) was obtained as 0.98 g/cc. So the proppant #1 and #3 are slightly lighter than water and the proppant #2 is slightly heavier than water. FIG. 3 shows the reaction product (clay-polymer composite) of clay and monomers. The material has intercalation of polymer in the clay platelets. FIG. 3 shows a broken piece of proppant #2 to show how polymer-clay bind each other.

Strength test of proppants: The strength of the proppants was evaluated using a HUMBOLDT strength test machine. The deformation behavior was tested at both room temperature and higher temperatures (95° C. and 120° C.).

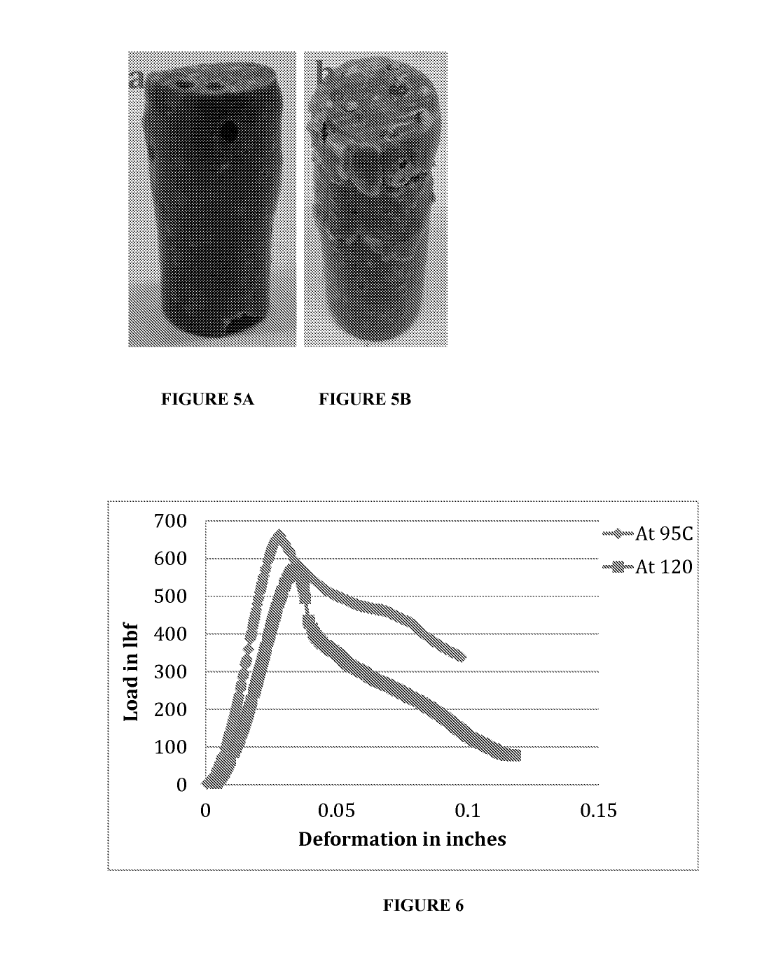

Proppant #1: FIG. 4 shows the strength test for proppant #1 at room temperature and 95° C. FIGS. 5A and 5B show the picture of the material before and after measurement at 95° C. The results are similar for room temperature and higher temperature.

FIG. 5A and 5B show Proppant #1 (L=1.1 inch, d=0.408 inch), before a crush test (FIG. 5A) and after a crush test at 95° C. (FIG. 5B).

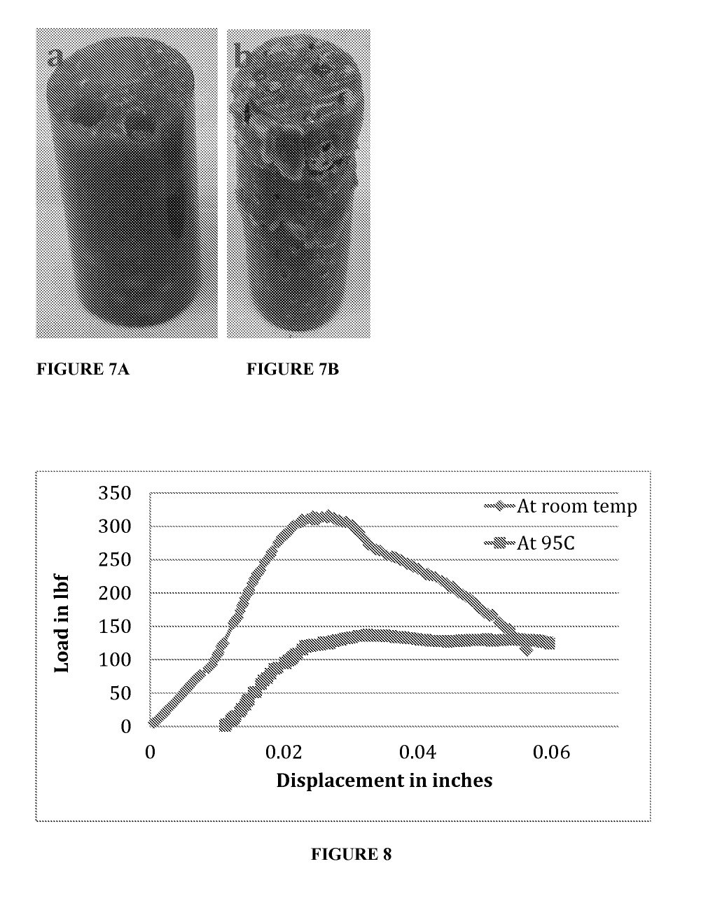

Proppant #2: Similarly, FIG. 6 shows the strength test for proppant #2 at 95° C. and 120° C. FIGS. 7A and 7B show the picture of the material before and after measurement at 95° C. The results are similar for room temperature and higher temperature. In FIGS. 7A and 7B the Proppant #2 (L=0.7 inch, d=0.33 inch) is shown, before a crush test (FIG. 7A) and after a crush test at 95° C. (FIG. 7B).

Proppant #3 (Graphite-polymer composite): This proppant has graphite instead of clay and it was also synthesized under similar conditions as shown in Scheme 1. FIG. 8 shows the strength test for Proppant #3 at room temperature and at 95° C. It was found that the proppant at room temperature was very strong but at higher temperature the strength was reduced. FIG. 8 is a graph that demonstrates the strength of proppant #3 at room temperature and at 95° C.

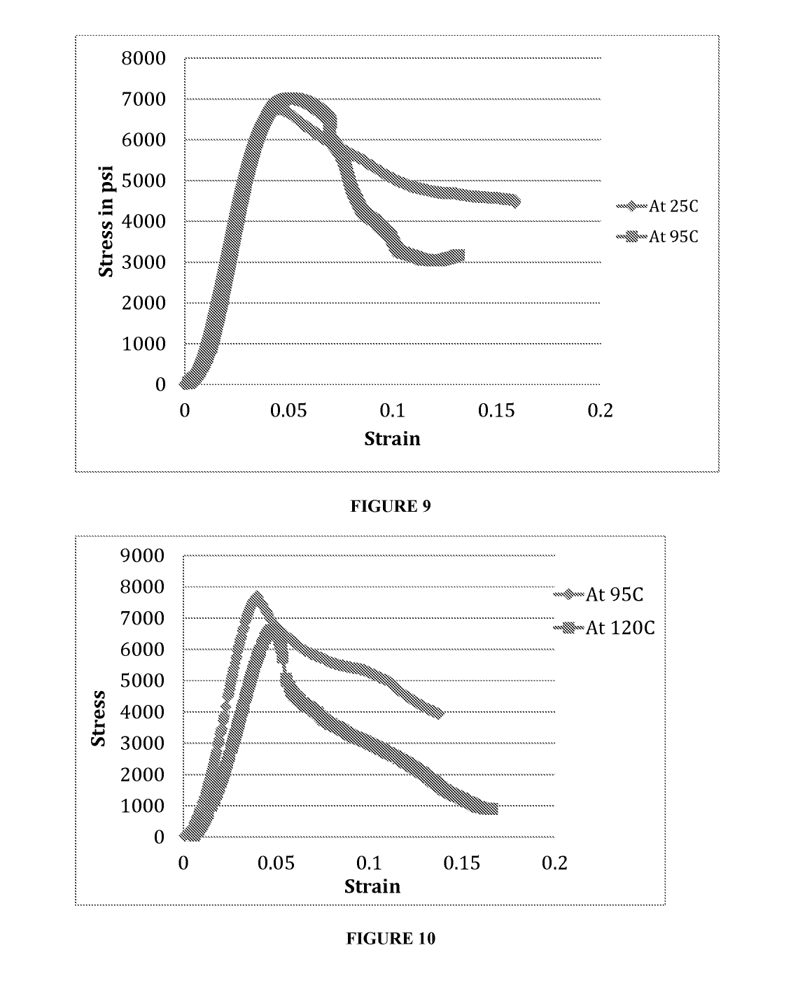

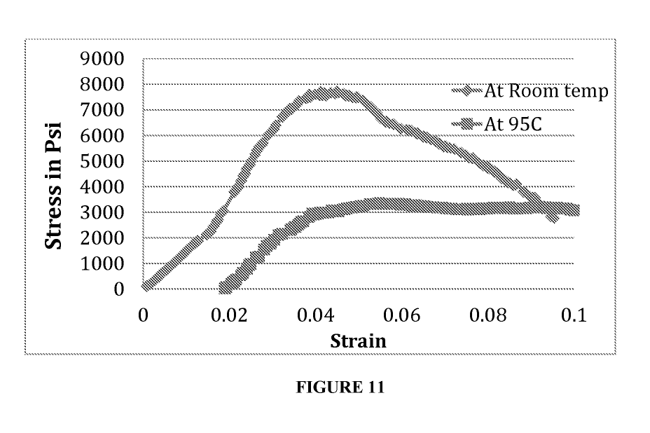

Deformability: The load-deformation data for all proppants (proppant #1, #2 and #3) have been converted to “effective stress” versus “effective strain” plots (FIGS. 9-11). The values of stress and strain have been calculated on the basis of the initial dimension of particles. It is an effective value because the particles deform and the distribution of stress is not uniform. A higher slope (or higher value of Young's modulus) indicates less deformability. The Young's modulus varies slightly for two different materials and decreases slightly as temperature increases for the same material. Young's modulus for proppant #1 is 185,081 psi (1,276,000 kPa) at room temperature and 171,703 psi (1,184,000 kPa) at 95° C. Similarly, Young's modulus for proppant #2 is 233,238 psi (1,608,000 kPa) at 95° C. and 167,392 psi (1,154,000 kPa) at 120° C. The Young's modulus for proppant #3 is 218,722 psi (1,508,000 kPa) at room temperature, but the value is very low (55,283 psi, 381,100 kPa) at 95° C. The proppant #3 is electrically conductive. This material could be stronger and conductive if mixed with some clay. The Young's modulus is lower at a higher temperature. Young's modulus for proppant #2 is higher than that of proppant #1 at 95° C. because of more amount of clay in proppant #2. There is a commercial proppant whose density is 1.08, but its Young's modulus at 95° C. is about 20,000 (137,900 kPa) psi (Gaurav et al., 2012). Thus, the newly synthesized proppants are about 10 times stronger than the commercially available light-weight proppants. FIG. 9 is a graph that shows the elastic modulus of proppant #1 at room temperature and at 95° C. FIG. 10 is a graph that shows the elastic modulus of proppant #2 at 95° C. and at 120° C. FIG. 11 is a graph that shows the elastic modulus of proppant #3 at room temperature and at 95° C.

Thus, it was found that: (1) Clay polymer composites and graphite polymer composites were synthesized by the reaction of clay or graphite with monomers in the presence of a trace amount of polymerization initiator. (2) Density of the synthesized materials was measured using heptane as a reference liquid. The materials were slightly lighter than water (proppant # 1 and #3) and slightly heavier (proppant # 2). The density of the material depends on the ratio of clay to monomer during reaction. (3) Strength and deformability of the materials were measured at the room temperature and at higher temperatures and Young's modulus was calculated. The clay-polymer composites are strong, about 10 times stronger than light-weight proppants available commercially. The clay-polymer with higher density has higher Young's modulus value than that of material with low density. Also, Young's modulus decreases with the rise of temperature. (4) The graphite-polymer composite is electrically conductive, but not very strong at 95° C. Composites of graphite-clay-polymer can be synthesized which are both strong and electrically conductive.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A lightweight proppant comprising:
a composite comprising a polymer and clay or graphite, wherein the composite has a density at or about the density of water or brine and the composite maintains its integrity at downhole pressures and temperatures.

2. The proppant of claim 1, wherein the clay is at least one of montmorillonite, kaolinite, hectorite, or smectite.

3. The proppant of claim 1, wherein the monomer is at least one of styrene, methyl methacrylate, propylene, or chloroprene.

4. The proppant of claim 1, wherein the polymerizing of the monomers into a polymer is conducted in the presence of at least one of acetonitrile, vinyl chloride, vinyl alcohol, acrylonitrile, benzoyl peroxide, or 2,2′-azobis(isobutyronitrile).

5. The proppant of claim 1, wherein the composite further comprises an additive that makes the proppant electrically conductive.

6. The proppant of claim 1, wherein the density of the composite is adjusted to approximate the density of the water or brine.

7. The proppant of claim 1, wherein the density of the composite is between 0.94 to 1.5 g/cc, 0.94 g/cc to 1.10 g/cc, 0.98 g/cc to 1.0 g/cc, 0.94 to 1.0 g/cc, or 0.94 to 0.98 g/cc.

8. The proppant of claim 1, wherein the clay or graphite to monomer ratio is 1:2.66 to 1:1.

9. The proppant of claim 1, wherein the proppant has a Young's Modulus of at least 50,000; 75,000; 100,000; 150,000; 175,000; 200,000; 225,000; 230,000 or greater.

10. A method of making a lightweight proppant comprising:
mixing clay or graphite with one or more polymer-forming monomers; and
polymerizing the monomers into a polymer, wherein the one or more monomers are selected to form, in combination with the clay or graphite, a composite comprising a polymer and clay or graphite, wherein the composite has a density at or about the density of water or brine and the composite maintains its integrity at downhole pressures and temperatures.

11. The method of claim 10, wherein the polymerization is in situ and comprises a polymerization at 50° C. to 70° C. for 2 to 8 hours, followed by second polymerization at 85° C. to 95° C. for 8 to 16 hours.

12. The method of claim 10, wherein the monomer is at least one of styrene, methyl methacrylate, propylene, or chloroprene.

13. The method of claim 10, wherein the polymerizing of the monomers into a polymer is conducted in the presence of at least one of acetonitrile, vinyl chloride, vinyl alcohol, acrylonitrile, benzoyl peroxide, or 2,2′-azobis(isobutyronitrile).

14. The method of claim 10, wherein the composite further comprises an additive that makes the proppant electrically conductive.

15. The method of claim 10, wherein the clay is at least one of montmorillonite, kaolinite, hectorite, or smectite.

16. The method of claim 10, wherein the density of the composite is between 0.94 g/cc to 1.5 g/cc, 0.94 g/cc to 1.10 g/cc, 0.98 g/cc to 1.0 g/cc, 0.94 to 1.0 g/cc, or 0.94 to 0.98 g/cc.

17. The method of claim 10, wherein the clay or graphite to monomer ratio is 1:2.66 to 1:1.

18. The method of claim 10, wherein the proppant has a Young's Modulus of at least 50,000; 75,000; 100,000; 150,000; 175,000; 200,000; 225,000; 230,000 or greater.

19. The method of claim 10, further comprising the steps of determining the density of the water or brine, preparing a sample of the proppant and determining the density of the proppant, and adjusting the density of the proppant to approximate the density of the water or brine.

20. The method of claim 10, wherein the water is at least one of a produced water, or the brine is a produced brine.

21. The method of claim 10, further comprising the step of determining a target density and adjusting the ratio of clay to monomer to the target density.

22. A method of fracturing a hydrocarbon bearing formation within a well comprising:
placing a proppant composite comprising a polymer and clay or graphite in a fracture, wherein the proppant composite has a density at or about the density of water or brine and the proppant composite maintains its integrity at well pressures and temperatures.

23. The method of claim 22, wherein the polymer is at least one of styrene, methyl methacrylate, propylene, or chloroprene.

24. The method of claim 22, wherein the polymer is made by polymerizing monomers into a polymer in the presence of at least one of acetonitrile, vinyl chloride, vinyl alcohol, acrylonitrile, benzoyl peroxide, or 2,2′-azobis(isobutyronitrile).

25. The method of claim 22, wherein the clay is at least one of montmorillonite, kaolinite, hectorite, or smectite.

26. The method of claim 22, wherein the density of the composite is between 0.94 g/cc to 1.5 g/cc, 0.94 g/cc to 1.10 g/cc, between 0.98 g/cc to 1.0 g/cc, 0.94 to 1.0 g/cc, or 0.94 to 0.98 g/cc.

27. The method of claim 22, wherein the clay or graphite to monomer ratio in the polymer is is 1:2.66 to 1:1.

28. The method of claim 22, further comprising the step of adding an additive that makes the composite electrically conductive.

29. The method of claim 22, wherein the proppant is introduced in a hydraulic fracturing fluid pumped into the well at sufficient pressure to fracture the formation.

30. The method of claim 22, wherein the proppant composite has a Young's Modulus of at least 50,000; 75,000; 100,000; 150,000; 175,000; 200,000; 225,000; 230,000 or greater.
